(19) United States
(12) Patent Application Publication
(10) Pub. No.: US 2017/0169341 A1
(43) Pub. Date: Jun. 15, 2017

(54) METHOD FOR INTELLIGENT RECOMMENDATION

(71) Applicants: LE HOLDINGS (BEIJING) CO., LTD., Beijing (CN); LE SHI INTERNET INFORMATION TECHNOLOGY CORP. BEIJING, BEIJING (CN)

(72) Inventor: Xue TANG, Beijing (CN)

(73) Assignees: LE HOLDINGS (BEIJING) CO., LTD., Beijing (CN); LE SHI INTERNET INFORMATION TECHNOLOGY CORP. BEIJING, Beijing (CN)

(21) Appl. No.: 15/246,498

(22) Filed: Aug. 24, 2016

Related U.S. Application Data
(63) Continuation of application No. PCT/CN2016/088506, filed on Jul. 5, 2016.

(30) Foreign Application Priority Data
Dec. 14, 2015 (CN) 201510926158.6

(51) Int. Cl. G06N 5/04

(52) U.S. Cl. CPC G06N 5/04

(57) ABSTRACT

A method is provided for intelligent recommendation. While detecting any terminal updates user data, the updated user data and user identification information are obtained. A recommended result according to the updated user data is generated, and the recommended result and the user identification information are correspondingly saved in the server.

### CROSS REFERENCE TO RELATED APPLICATIONS

This application is a continuation of International Application No. PCT/CN2016/088506, filed Jul. 5, 2016, which is based upon and claims priority to Chinese Patent Application No. 201510926158.6, filed Dec. 14, 2015, the entire contents of which are incorporated herein by reference.

### TECHNICAL FIELD

The present disclosure relates to video display technology, more particularly to a method and server for displaying intelligent recommendation on multi-terminals.

### BACKGROUND

The internet of things (IoT) is widely used in daily life, it provides lots of information to satisfy the user's information requirement. However, with the development of internet, users are overwhelmed with too much information, the users may have problem to decide which information is useful, and they may spend too much time on filtering these information, it is called “information overload”. For example, E-Commerce is becoming an increasingly popular business model, it may offer many choices for the customers, but offering too many choices will actually alienate and confuse the customers, or even lose potential customers.

In General, intelligent recommendation system is used to solve the aforementioned “information overload” problem. Based on the requirement of the users, the intelligent recommendation system may provide information, products that are useful to and interest the users. By comparing with the traditional search engine, the intelligent recommendation system studies users' personal information and does customized calculations, so it may find what interest the users, and guide the users to find their need. A good intelligent recommendation system not only may provide the users with customized services, but also may build good relationship with the users to make them become more reliable on the system.

With the development of the intelligent devices, the intelligent recommendation system is widely used on these devices. However, for the same user, his/her devices each has an intelligent recommendation system, so the recommended results of different devices are usually different from one another, and therefore it is hard to catch user's behavior. Accordingly, the user's interest models among these devices will be different, which affects the qualities of the intelligent recommendations system. For example, a company has products at PC end, APP end and TV end, if recommendations provided by these ends are not consistent, the user experience is affected, and the user may not rely on the video at these ends.

### SUMMARY

The present disclosure provides a method and server for displaying intelligent recommendation for solving problems that the recommendations provided by the traditional intelligent recommendation system are not consistent at different terminals.

One embodiment of the present disclosure provides a method for displaying intelligent recommendation. The method includes:

obtaining updated user data and user identification information while any terminal detects the updated user data;

obtaining a recommended result according to the updated user data, and saving the recommended result and the user identification information correspondingly into a server;

obtaining the user identification information while any terminal requests for the recommended information, reading the recommended result corresponding to the user identification information from the server, pulling respective recommended information from the recommended result, pulling respective recommendation information from the recommended result, and displaying the recommended information on the respective terminal.

One embodiment of the present disclosure provides a non-volatile computer storage medium capable of storing computer-executable instruction. The said computer-executable instruction is used for performing any one of the step in above.

The present disclosure provides a server including at least one processor and a data storage. The data storage stores at least one process which may be performed by the processor. The computer-executable instruction is performed by the at least one processor so that the at least one processor may perform any one of the step as discussed in above.

The method and server of the present disclosure, user's behavior obtained via each terminal is used to build user interest model, and recommended results are saved into the same server according to the interest models. When different terminals provide recommended results to the same user, data is pulled from the same server according to the user identification information. Accordingly, the recommended results provided from different terminals are consistent, which is convenient for the user to get information at all ends. In such a case, it is favorable for precise obtaining user's behavior via each terminal, building user's interest model, and providing more precise recommended information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram illustrating some embodiments of the present disclosure;

FIG. 2 is a flow diagram illustrating some embodiments of the present disclosure;

FIG. 3 is a flow diagram illustrating some embodiments of the present disclosure;

FIG. 4 is a configuration view of a device according to some embodiments of the present disclosure; and

FIG. 5 is a configuration view of a server according to some embodiments of the present disclosure.

### DETAILED DESCRIPTION

For a better understanding of the present disclosure, detailed description of embodiments in conjunction with the figures are described in the following paragraphs. In general, a computer apparatus may include one or more processors (e.g. CPU), input/output (I/O), internet ports and memories.

The memory may be a computer readable medium such as a volatile memory, a random-access memory (RAM) and/or a non-volatile memory. For example, the memory is a read-only memory (ROM) or a flash RAM. The memory is an example of a computer readable medium.

A computer readable medium may be volatile or non-volatile. Movable medium and non-movable medium may store data by any method or technology. The computer readable medium is a medium capable of storing data in a format readable by a mechanical device. Information may be signal readable by computers, data structure, program module or other data forms. The memory is, for example, a parameter random access memory (PRAM), a static random-access memory (SRAM), a dynamic random-access memory (DRAM), other types of RAM, a read-only memory (ROM), an electrically erasable programmable read-only memory (EEPROM), a flash memory, other types of memory technology, a compact disc read-only memory (CD-ROM), a digital versatile disc (DVD), other types of optical storages, a cassette tape recorder, other types of formats using magnetic tape recording, or other devices which may store data and be read by computer. In addition, the computer readable medium does not include transitory media such as modulated signal and carrier wave.

As used in the specification and claims which certain terms are used to refer to a specific component. Skilled in the art will appreciate, manufacturers may use different terms to refer to the same component. This specification and the claims are not to be differences in the names of the components as a way to distinguish, but the difference in a component to function as a criterion to distinguish. As mentioned throughout the specification and claims, and among “comprising” is an open-ended term, it should be interpreted to mean “including, but not limited to. “Approximately” means within an acceptable error range, those skilled in the art to solve the problem within a certain error range, to achieve the basic technical effect. In addition, “coupled” as used in this is included with any direct and indirect electrical connection means. Therefore, if the paper describes a first device is coupled to a second device, the first device may represent a direct electrical connection to the second device, or connected to the second device through other means or indirectly electrically connecting means. The following descriptions in the specification are the preferred embodiment of the present application, and the purpose of the description are the general principles of this application but not intended to limit the scope of the application. When the scope of the application depends on the appended claims and their equivalents.

It is further noted that the term “comprising”, “including” or any other variation thereof, are intended to cover a non-exclusive inclusion, such that a series of factors including the process, method, merchandise or system includes not only those elements, but also include other elements not expressly listed or for such further comprising process, method, or system merchandise inherent feature. Without more constraints, by the statement “includes a . . . ” defined elements, does not exclude the existence of additional identical elements in the process include the elements, methods, goods or system.

Furthermore, the term “server” may be one server device or a server including plural server devices for sharing the loading. Therefore, it may be understood that the server in the present disclosure may be a server group consisting of plural server devices.

In some embodiments of the present disclosure, a method for displaying intelligent recommendation is provided, and it may be adapted to a system for offering recommendations, such as video recommendation system, product recommendations in e-commence or the other.

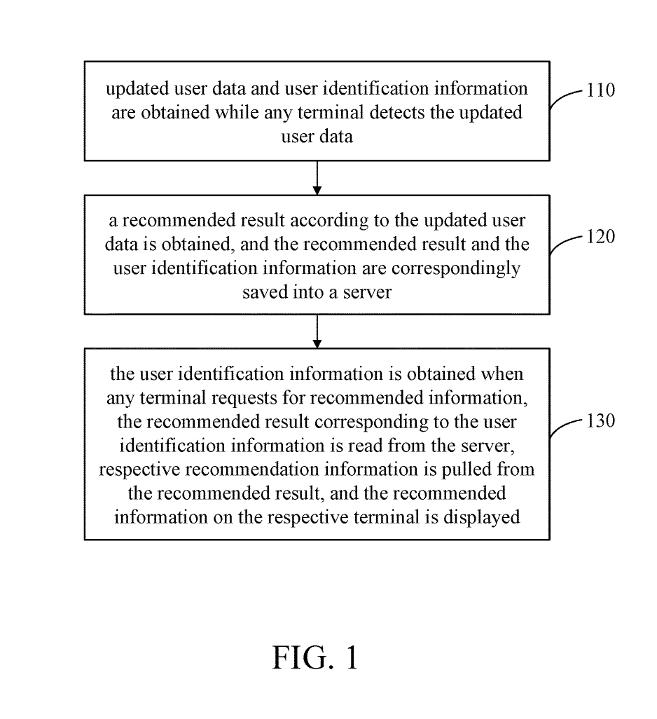

FIG. 1 is a flow diagram illustrating some embodiments of the present disclosure. As shown in FIG. 1, the method for displaying intelligent recommendation at a server end is implemented by the following steps:

In Step 110: updated user data and user identification information are obtained while any terminal detects the updated user data;

In some embodiments, the updated user data may include user's current operation to the current information, digital footprints, and search history and how long a user has stayed on a certain page. For example, in a video display apparatus, the user data may be information of how the user selects a video from current video playlist, the content of the selected video, the keywords searched by the user, the video categories selected by the user, the videos shared by the user, and the rate gave by the user. In another example, in electronic commerce, the user data may be product categories and brands selected by the user, how long a user has stayed on a product, and the comment wrote by the user.

For the purpose of obtaining the user identification information, the aforementioned user data is exclusive to the specific account information, and the user data and the specific account information are saved into the server. Therefore, when the user logs into different terminals with the same account, an order of recommended product categories and orders of recommended information in each product category are in related to the user's interest, and consistent at all the terminals. If the user does not log in while browsing the content (e.g. products), the user's IP address is obtained for building a unique connection with the user data. Thus, the user interests and the related recommendations are still implementable. In some embodiments, the terminal includes Web end, mobile phone end and TV end. Each of the ends has only one identification number (ID number), so the user may access to the terminals via these ID numbers to get his/her interest data and recommendations.

In Step 120: a recommended result according to the updated user data is obtained, and the recommended result and the user identification information are correspondingly saved into a server;

Optionally, the recommended results is calculated by combining pr-modeled interest models, and the user's interest may be determined according to the updated user data, that is, potential user interests may be found by analyzing the features of the user's interest. For example, at the user end, if the series is a war TV series, and the user stayed on watching this series for a long time, the background obtains the search result and analyze this series to obtain it's subject, style, era covered by the series and content.

In some embodiments, the features analysis may be implemented by referring the pre-built feature labels. According to the referred pre-built feature labels, the respective pre-trained interest model in the server is selected for generating a recommended result and the recommended result and the obtained user identification information are saved into the server.

In Step 130: the user identification information is obtained when any terminal requests for recommended information, the recommended result corresponding to the user identification information is read from the server, respective recommendation information is pulled from the recommended result, and the recommended information on the respective terminal is displayed.

Accordingly, all the terminals share the same data, and the data may be stored in plural servers. The present disclosure is not limited to the amount of the servers. When the user requests the recommended result through Web end, App. or TV end, the recommended result all comes from the same database, which ensures that the recommended result on all ends are consistent. In some embodiments, user's current operation mode is detected in real time and combined with user's account information, user's customized recommended result is generated according to the pre-built interest model, and then the recommended result is saved into the unitary database. Accordingly, when a user needs recommendation, all the terminal may provide the same recommended result, which is convenient for the user, and thereby improving user experience.

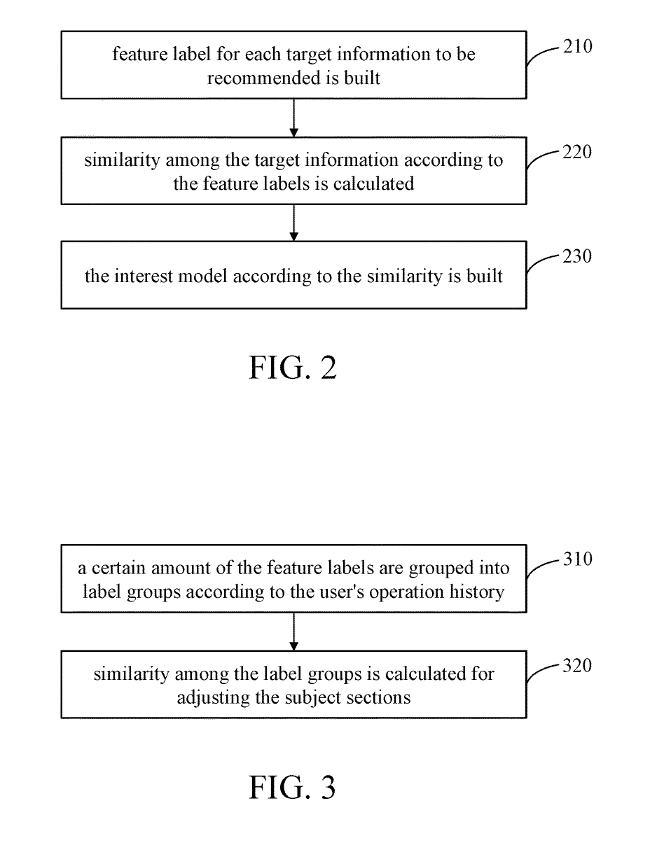

Then, please refer to FIG. 2, which is a flow diagram illustrating some embodiments of the present disclosure. As shown in FIG. 2, a method for modeling interest model includes:

In step 210: feature label for each target information to be recommended is built;

In some embodiments, the recommended information is determined by user interest model built by feature labels of waiting information (information to be recommended). The feature label is a mark for the information to be recommended. The present disclosure is not limited to the amount of the feature labels corresponding to each information to be recommended, it may be altered according to, for example, the features of the information to be recommended. And the feature label is preferable to cover all the features of the waiting information whenever possible in order to provide more precise recommendation. For example, the feature labels of video may be “comedy”, “Taiwan/Hong Kong”, “Adventure”, “Idol”, “Animation”, “War”, “Vintage” and the others, and these labels somehow represent the spirit of the videos. In addition, the features labels for videos may further include “Main character”, “Director” and others which may highly represent the videos as well. For each product (e.g. video), it may include labels basic information relating to style, brand, source or the others.

In Step 220: similarity among the target information according to the feature labels is calculated;

In some embodiments, a method to calculate similarity is analyzing the relation between the user's operation history and the information to be recommended. The purpose to do so is to get the information most relating to the user's operation history by analyzing user interest. If it is lacked of user's operation history, and the user interest is low in diversity, there may have only one feature label in one category. For example, one label “comedy” in video style, and one label “Huang Bo” in Main character. Specifically, the potential useful information for the user may be found by analyzing the user's operation history, the feature labels corresponding to the potential useful information may be taken as feature label references, similarity among the target information on the recommendation list and the feature label references are calculated, and then the potential useful information to the user according to the result of the calculation are recommended. It is noted that the user's operation history includes the user's operation history on each terminal during a certain period of time.

In some embodiments, the feature label may be one of the dimensions for calculating the similarity. The similarity may be calculated according to a vector distance formula.

Specifically, similarity between two of the feature labels is implemented by using Cosine Similarity which is a measure of similarity between two vectors of an inner product space that measures the cosine of the angle between them. Firstly, vectors are illustrated on a two dimensional vector space by referring their coordinates. Then, the cosine of the angle between them is calculated, and the cosine value represents the similarity between these two vectors. When the cosine value is close to 1 when it ranges between [−1,1], the directions of the two vectors are close to 0, which means that their directions are consistent, and the similarity between the two vectors are higher.

In some embodiments, the similarity may also be calculated by using Jaccard similarity coefficient and Pearson product-moment correlation coefficient.

The Jaccard similarity coefficient is a statistic used for comparing the similarity and diversity of sample sets. Here is an example of measuring the sample sets A and B by using Jaccard similarity coefficient:

Jaccard (A, B)=|A intersect B|/|A union B|;

When the similarity ranges between [0, 1], and A==B, Jaccard (A, B)=1.

The Pearson product-moment correlation coefficient is a measure of the linear correlation between two variables X and Y. The Pearson product-moment correlation coefficient is a value between +1 and −1 inclusive, where 1 is total positive correlation, 0 is no correlation, and −1 is totally negative correlation. It is widely used in the sciences as a measure of the degree of linear dependence between two variables. It was developed by Karl Pearson from a related idea introduced by Francis Galton in the 1880s.

In Step 230: the interest model according to the similarity is built. In some embodiments, the method for building the interest model includes Collaborative Filtering, Decomposition/Factorization, Graph Based Model, Latent Factor Model, Logistic regression and the others, but the present disclosure is not limited thereto.

Collaborative Filtering recommendation, also called CF, includes item-based CF and user-based CF. The item-based CF uses user rating data to compute the similarity among items, and provides recommendation based on the similarity among items. The user-based CF uses user rating data to compute the similarity among users, and provides recommendation base on the similarity among users. For example, when it comes to video recommendation, CF is used to compute the similarity among videos or users. For example, “Those people who like this video may also like these videos” and “You may also be interested in these videos” are the results based on CF. Logistic Regression (LR) firstly uses Gradient descent, Stochastic gradient descent or another algorithm to build a model of waiting information feature labels, the model is a final result after being rebuilt many times based on user's operation history, and a related value of the user and the feature labels is obtained by using sigmoid function. The related value ranges 0 to 1. When the related value is between 0 and 0.5, it means that the user has low interest in the information related to the feature labels. When the related value is between 0.5 and 1, it means that the user has high interest in the information related to the feature labels, so a model consisted of these feature labels may be recommended. In addition, the items related to these high interested feature labels may be sorted by subject by using CF, the subject may be arranged according the user's interest level and user interest. In such a case, in the same subject, it is allowed to display a certain amount of recommended information. The way to arrange the recommended information, for example, the sequence of the recommended information is obtained according to the recommended model.

In some embodiments, interest model is updated according to the user behavior. When the recommended information is displayed on the terminal, the operation result of the user relating to the recommended information is obtained, and the operation result and the user identification information are saved into the server for updating the interest model. That is, the data of how the user operate and how the user select the recommended information is the latest data, and the latest data may continuously remodel the interest model for providing useful recommendation to the user.

In some embodiments, the feature label is built according to the information to be recommended. A user interest model is built by using recommendation algorithm, so the information which meets user's interest is obtained according to the updated user data, and thereby updating information for user.

Then, please refer to FIG. 3, which is a flow diagram illustrating some embodiments of the present disclosure. As shown in FIG. 3, another method for calculating similarity among the target information includes:

In Step 310: a certain amount of the feature labels are grouped into label groups according to the user's operation history, and subject sections according to the label groups are generated;

In some embodiments, if the user's operation history is big, a certain amount of the feature labels may be grouped into label groups according to different subjects, and then subject sections are generated as a recommendation to the user. The label group is generated according to the user's operation history. For example, if a user has a lot of records on watching videos of Huang Bo, giving high rate to his videos, and sharing his videos many times, the feature labels may include “Huang Bo”, “Comedy” or “Funny” and other feature labels, and the labels of “Main character” and “video style” may be grouped as a label group, that is, a subject section of “a comedy movie of Huang Bo”.

In Step 320: similarity among the label groups is calculated for adjusting the subject sections.

In this step, the adjustment of the subject sections includes: placing the target information to be recommended in each subject section in order; and adjusting the order of different subject sections.

In this step, the calculation of similarity among the subjects from the label groups is used to delete the repeated subject section and arrange the recommended information in each subject. For example, “Stephen Chow's comedy movies” and “Stephen Chow's funny movies” have no much difference from each other, and it will be a bad user experience if the similar subjects are displayed at the same time. Therefore, in some embodiments, the similar or the repeated subject section of the label groups is deleted according to the calculation of similarity. Hence, in the previous example, although “Stephen Chow's comedy movies” and “Stephen Chow's funny movies” are divided into two subjects, and then be put into two recommended sections during the identification, but they are put into the same recommended section after the calculation of similarity in order to provide the user more precise and useful recommendations.

In addition, if the recommended sections in the same subject have plural target information to be recommended, it is important to improve user experience by arranging these target information. In some embodiments, similarity among the target information to be recommended in the same subject section and the subject of the section is calculated, and the target information to be recommended in the same recommended section is arranged from highly correlated to less correlated by the result of similarity calculation. Therefore, the recommended information at the top of the list, or the first recommended information the user would see will be the information of most interest to the user, that is, the user may see the most useful information first. In addition, in some embodiments, arrangement of the subject sections is according to the user's operation history during a certain period of time. In specific, the ratings and other information of the subject sections given by the user during a certain period of time are calculated. For example, the number of views of each subject section, the time that the user spend on each subject section, the number of sharings of each subject section and the comments may be comprehensively evaluated for rating each of the subject sections, and the subject sections may be arranged by the rating. It is noted that the order of the subject sections are continuously updated according to user's data, so it is favorable for following user's interest or predicting users' potential interest, and thereby making the users become more rely on the recommended information.

In some embodiments, according to the user's operation history, an amount of labels are formed into a subject recommended section so that the similar recommended information are combined, and the recommended information may be more useful to user's interests, and thereby improving user experience.

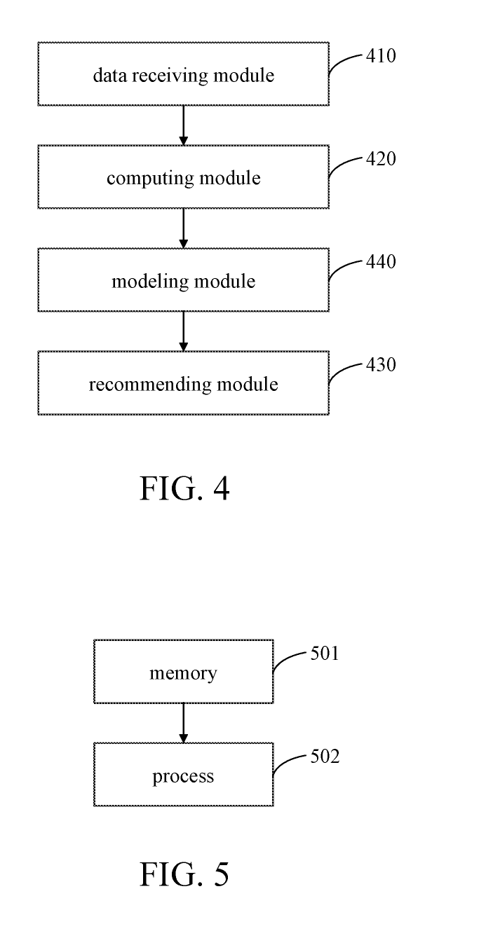

Then, please refer to FIG. 4, which is a configuration view of a device according to some embodiments of the present disclosure. As shown in FIG. 4, a device for providing intelligent recommendation is provided, which includes a data receiving module 410, a computing module 420, a recommending module 430 and a modeling module 440.

When the data receiving module 410 detects any the terminal updating the user data, the updated user data and the user identification information are obtained.

The computing module 420 and the data receiving module 410 are connected, for obtaining a recommended result according to the updated user data, and correspondingly saving the recommended result and user identification information into the server.

Optionally, the computing module 420 is able to calculate the recommended result by combining pr-modeled interest models according to the updated user data.

When any terminal requests the recommended information, the recommending module 430 is able to obtain the user identification information, and read the recommended result corresponding to the user identification information from the server, for obtaining the recommended information selected from the recommended result and displaying the obtained recommended information on the terminal.

The computing module 420 is configured to perform feature analysis on the updated user data to obtain the corresponding feature label, and to find the pre-built interest model according to the feature label to search the recommended result.

The modeling module 440 and the connected computing module 420 are configured to generate feature labels for each target information to be recommended, calculate similarity among the target information according to the feature labels, and build the interest model according to the similarity.

The modeling module 440 is able to build label groups by gathering a certain amount of the feature labels, and calculate similarity among the label groups.

The user identification information may include a user account, an IP address, and a device ID number.

The data receiving module 410 is connected to the modeling module 440. The data receiving module 410 is configured to monitor an operation result of the user to the recommended information after displaying the recommended information on the respective terminal, and then the data receiving module 410 saves the operation result and the respective user identification information correspondingly into the server for updating the interest model.

The methods in FIGS. 1-3 may be implemented on the device in FIG. 4, they share the similar techniques and methodologies and have similar technical effects.

One embodiment provides a non-volatile computer storage medium capable of storing computer-executable instruction. The said computer-executable instruction is used for performing any one of the step in above.

Then, please refer to FIG. 5, which is a configuration view of a server according to some embodiments of the present disclosure. As shown in FIG. 5, a server for providing intelligent recommendation is provided, which includes a memory 501 and one or more processors 502. FIG. 5 is an example showing that the server having one processor 502.

The memory 501 is configured to store one or more computer-executable instruction for the processor, wherein the computer-executable instruction is used for the processor to perform.

The processor 502 is configured to obtain the updated user data and the user identification information when any terminal detects the updated user data.

The recommended result is obtained according to the updated user data, and the recommended result and the user identification information are correspondingly saved into the server.

When any terminal requests the recommended information, the user identification information is obtained to read the recommended result corresponding to the user identification information from the server for pulling respective the recommended information from the recommended result, and the recommended information is displayed on the respective terminal.

When the recommended result is obtained according to the updated user data, the processor 502 performs features analysis on the updated user data to generate feature label, and then review the recommended result by calling a pre-built interest model according to the feature label.

The processor 502 may pre-building the interest model by the following process: building up feature label for each target information to be recommended; calculating similarity among the target information according to the feature labels; and building the interest model according to the result of the similarity calculation.

In specific, when calculating the similarity among the target information according to the feature labels, the processor 502 is able to build label groups by a certain amount of feature labels, and calculate similarity among the label groups.

The user identification information includes a user account, an IP address and a device ID number.

The processor 502 is able to monitor the operation result of the user to the recommended information after displaying the recommended information on the respective terminal, and then the processor 502 saves the operation result and the respective user identification information correspondingly into the server for updating the interest model. The apparatus may include an input device and an output device.

The processor 610, memory 620, the input device and the output device may be connected to each other via a bus or other members for electrical connection. In FIG. 6, they are connected to each other via the bus in this embodiment.

The memory 501 is one kind of non-volatile computer-readable storage mediums applicable to store non-volatile software programs, non-volatile computer-executable programs and modules; for example, the program instructions and the function modules (the data receiving module 410, the computing module 420, the recommending module 430 and the modeling module 440 in FIG. 4) corresponding to the method in the embodiments are respectively a computer-executable program and a computer-executable module. The processor 41 executes function applications and data processing of the server by running the non-volatile software programs, non-volatile computer-executable programs and modules stored in the memory 501, and thereby the methods in the aforementioned embodiments are achievable.

The memory 501 may include a program storage area and a data storage area, wherein the program storage area may store an operating system and at least one application program required for a function; the data storage area may store the data created according to the usage of the device for intelligent recommendation. Furthermore, the memory 501 may include a high speed random-access memory, and further include a non-volatile memory such as at least one disk storage member, at least one flash memory member and other non-volatile solid state storage member. In some embodiments, the memory 501 may have a remote connection with the processor 502, and such memory may be connected to the device of the present disclosure by a network. The aforementioned network includes, but not limited to, internet, intranet, local area network, mobile communication network and combination thereof.

The input device may receive digital or character information, and generate a key signal input corresponding to the user setting and the function control of the device for intelligent recommendation. The output device may include a displaying unit such as screen.

The one or more modules are stored in the memory 501. When the one or more modules are executed by one or more processor 502, the method of intelligent recommendation disclosed in any one of the embodiments is performed.

The aforementioned product may perform the method of the present disclosure, and has function module for performing it. The details not thoroughly illustrated in this embodiment may be referenced via the methods in the present disclosure.

The methods in FIGS. 1-3 may be implemented on the device in FIG. 5, they share the similar techniques and methodologies and have similar technical effects.

The server in the embodiments of the present application is presence in many forms, and the server includes, but is not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus may display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other servers having a data exchange function.

The aforementioned embodiments are exemplary, the description of separated units may be physically connected, and the unit capable of displaying image may not be a physical unit, that is, it may be located on a place or distributed to plural internet units. It is optionally to select a part or all of the modules for achieving the purpose of the present disclosure.

By the aforementioned embodiments, the people skilled in the art may thoroughly understand that the embodiments may be implemented by software and hardware platform. Accordingly, the technique, features or the part having contribution may be embodied through software product, the software product may be stored in computer readable medium, such as ROM/RAM, hard disk, optical disc, including one or more instructions so that a computing apparatus (e.g. personal computer, server, or internet apparatus may execute each embodiment or some methods discussed the embodiments.

It is further noted that: the embodiments above are only used to explain the features of the present application, but not used to limit the present application; although the present application is explained by the embodiments, the people skilled in the art would know that the features in the aforementioned embodiments may be modified, or a part of the features may be replaced, and the features relating to these modification or replacement are still in the scope and spirit of the present application.

What is claimed is:

1. A method for displaying intelligent recommendation on multi-terminals, comprising:
obtaining updated user data and user identification information while any terminal detects the updated user data;
obtaining a recommended result according to the updated user data, and saving the recommended result and the user identification information correspondingly into a server;
obtaining the user identification information when any terminal requests for recommended information, reading the recommended result corresponding to the user identification information from the server, pulling respective recommendation information from the recommended result, and displaying the recommended information on the respective terminal.

2. The method according to claim 1, wherein the obtaining the recommended result according to the updated user data comprises:
obtaining corresponding feature label by performing feature analysis on the updated user data; and
generating the recommended result by calling a pre-trained interest model according to the feature label.

3. The method according to claim 2, further comprising:
pre-training the interest model, and the pre-training the interest model comprises:
building feature labels for each target information to be recommended, and calculating similarity among the target information according to the feature labels; and
building the interest model according to the similarity.

4. The method according to claim 3, wherein the calculating the similarity among the target information according to the feature label comprises:
building label groups according to a certain amount of the feature labels, and calculating similarity among the label groups.

5. The method according to claim 1, wherein the user identification information comprises one of a user account, an IP address and a device identification number.

6. The method according to claim 1, further comprising:
monitoring an operation result of the user to the recommended information after displaying the recommended information on respective terminal, and saving the operation result and the user identification information correspondingly into the server for updating the interest model.

7. A non-volatile computer storage medium having stored therein instructions that, when executed by a server, cause the server to:
obtain updated user data and user identification information while any terminal detects the updated user data;
obtain a recommended result according to the updated user data, and save the recommended result and the user identification information correspondingly into a server; and
obtain the user identification information when any terminal requests for recommended information, read the recommended result corresponding to the user identification information from the server, pull respective recommendation information from the recommended result, and display the recommended information on the respective terminal.

8. The non-volatile computer storage medium according to claim 7, wherein the step to obtain the recommended result according to the updated user data comprises:
obtaining corresponding feature label by performing feature analysis on the updated user data; and
generating the recommended result by calling a pre-built interest model according to the feature label.

9. The non-volatile computer storage medium according to claim 8, wherein the server is further caused to pre-build the interest models, the step to pre-build the interest models comprises:
building feature labels for each target information to be recommended, and calculating similarity among the target information according to the feature labels; and
building the interest model according to the similarity.

10. The non-volatile computer storage medium according to claim 9, wherein the step to calculate the similarity among the target information according to the feature label comprises:
building label groups according to a certain amount of the feature labels, and calculating similarity among the label groups.

11. The non-volatile computer storage medium according to claim 7, wherein the user identification information comprises one of a user account, an IP address and a device identification number.

12. The non-volatile computer storage medium according to claim 7, wherein the server is further used to:
monitor an operation result of the user to the recommended information after displaying the recommended information on respective terminal, and saving the operation result and the user identification information correspondingly into the server for updating the interest model.

13. A server, comprising:
at least one processor; and
a data storage communicatively connected to the at least one processor; wherein
the data storage stores computer-executable instruction which is performed by the at least one processor, when the computer-executable instruction is performed by the at least processor, the at least one processor is caused to:
obtain updated user data and user identification information while any terminal detects the updated user data;
obtain a recommended result according to the updated user data, and save the recommended result and the user identification information correspondingly into the server; and
obtain the user identification information when any terminal requests for recommended information, read the recommended result corresponding to the user identification information from the server, pull respective recommendation information from the recommended result, and display the recommended information on the respective terminal.

14. The server according to claim 13, wherein the step to obtain the recommended result according to the updated user data comprises:
obtaining corresponding feature label by performing feature analysis on the updated user data; and
generating the recommended result by calling a pre-built interest model according to the feature label.

15. The server according to claim 14, wherein the at least one processor performs steps of pre-builting the interest model, the steps comprises:
building feature labels for each target information to be recommended, and calculating similarity among the target information according to the feature labels; and
building the interest model according to the similarity.

16. The server according to claim 14, wherein the step of calculating the similarity among the target information according to the feature label comprises:
building label groups according to a certain amount of the feature labels, and calculating similarity among the label groups.

17. The server according to claim 13, wherein the user identification information comprises one of a user account, an IP address and a device identification number.

18. The server according to claim 13, wherein the at least one processor is further caused to:
monitor an operation result of the user to the recommended information after displaying the recommended information on respective terminal, and saving the operation result and the user identification information correspondingly into the server for updating the interest model.
